(19) United States
(12) Patent Application Publication
(10) Pub. No.: US 2012/0080243 A1
(43) Pub. Date: Apr. 5, 2012

(54) REMOVABLE MOTOR ASSEMBLY FOR WHEELCHAIRS

(76) Inventor: James P. Mulhern, Nanticoke, PA (US)

(21) Appl. No.: 13/253,286

(22) Filed: Oct. 5, 2011

Related U.S. Application Data
(60) Provisional application No. 61/389,958, filed on Oct. 5, 2010.

(51) Int. Cl. A61G 5/04; B23P 11/00; A61G 5/02

(52) U.S. Cl. 180/11; 29/428

(57) ABSTRACT

A motor assembly for a wheelchair and a corresponding method of use are provided for conversion of a manual wheelchair into a powered wheelchair. The motor assembly includes a crossbar, a motor mount bracket, and a motor that is attached to the crossbar by the motor mount bracket. The motor mount bracket includes a front plate and a back plate that is attached to the front plate by a hinge. The back and front plates are capable of clamping on to the crossbar after the crossbar has been attached to the wheelchair. The crossbar further includes collars that center the drive wheels to the wheelchair when the motor is attached to the crossbar.

### CROSS REFERENCE TO RELATED APPLICATIONS

This application claims the benefit of U.S. Patent Application Ser. No. 61/389,958 filed Oct. 5, 2010 the contents of which are hereby incorporated by reference herein.

### BACKGROUND

Wheelchairs are a crucial means of mobility for a significant portion of the general population. Wheelchairs are generally divided in to two types: manual or powered. Manual wheelchairs are propelled by the wheelchair user or the wheelchair user's caregiver. Powered wheelchairs are generally propelled by at least one motor that is usually controlled by the wheelchair user.

Manual wheelchairs may be converted into powered wheelchairs for wheelchair users that need full or partial assistance for movement. One way to convert a manual wheelchair into a powered wheelchair is to mount a motor to the wheelchair. While various methods of mounting a motor to a wheelchair are known in the art, they are generally cumbersome and difficult to use when the wheelchair needs to be transported.

### SUMMARY

In an embodiment, a removable motor assembly is configured to be removably attached to a manual wheelchair. The removable motor assembly includes a crossbar, a motor operatively coupled to a pair of motor assembly drive wheels, a back plate coupled to the motor, and a front plate rotatably coupled to the back plate. The crossbar includes a first collar and a second collar spaced apart from the first collar along the crossbar. The crossbar is configured to couple to a frame of the manual wheelchair. The front plate is rotatably coupled to the back plate between a clamped position in which the back and front plates are clamped on to a portion of the cross bar between the first and second collars to thereby affix the motor to the crossbar, and an unclamped position in which the motor is removed from the crossbar.

In another embodiment, a removable motor assembly is configured to be removably attached to a manual wheelchair. The removable motor assembly includes a crossbar, a motor operatively coupled to a pair of motor assembly drive wheels, and a motor mount bracket coupled to the motor. The crossbar includes a first portion and a second portion that is slidably coupled to the first portion such that the first portion is compressible relative to the second portion. The second portion defines a centering feature. The motor mount bracket is configured to have a clamped position in which the motor mount bracket is coupled to the crossbar to thereby affix the motor to the crossbar, and an unclamped position in which the motor mount bracket and motor are removed from the crossbar. The motor mount bracket is automatically centered on the second portion of the crossbar by the centering feature when the motor mount bracket is clamped onto the crossbar.

In another embodiment a method of mounting a motor assembly to a manual wheelchair includes attaching a crossbar to a frame of a manual wheelchair by sliding a first portion of the crossbar relative to a second portion of the crossbar so as to expand a length of the crossbar. The method further includes providing a motor and a motor mount bracket attached to the motor. The motor is operatively coupled to a pair of motor assembly drive wheels. The motor mount bracket includes a back plate that is attached to the motor, and a front plate that is rotatably attached to the back plate by a hinge. The front plate is rotated about the hinge to thereby provide access to a channel that is defined by the front plate. The motor mount is positioned such that the crossbar is between the front and back plates. The front plate is then rotated about the hinge such that the crossbar is received within the channel defined by the front plate.

### BRIEF DESCRIPTION OF THE DRAWINGS

FIG. 1 is a perspective view of a wheelchair assembly constructed in accordance with one embodiment, the wheelchair assembly including a wheelchair and a removable motor assembly removably attached to the wheelchair;

FIG. 2 is a partial top plan view showing the removable motor assembly attached to the wheelchair of FIG. 1;

FIG. 3 a perspective view of the removable motor assembly shown in FIG. 1, the removable motor assembly including a cross-bar, a motor, and a motor mount that couples the motor to the cross-bar;

FIG. 4A is a side sectional view of the removable motor assembly shown in FIG. 3 with the motor mount in an unclamped position;

FIG. 4B is a side sectional view of the removable motor assembly shown in FIG. 4A with the motor mount in a clamped position;

FIG. 5A is a front elevation view of the removable motor assembly shown in FIG. 3; and

FIG. 5B is a back elevation view of the removable motor assembly shown in FIG. 3.

### DETAILED DESCRIPTION OF ILLUSTRATIVE EMBODIMENTS

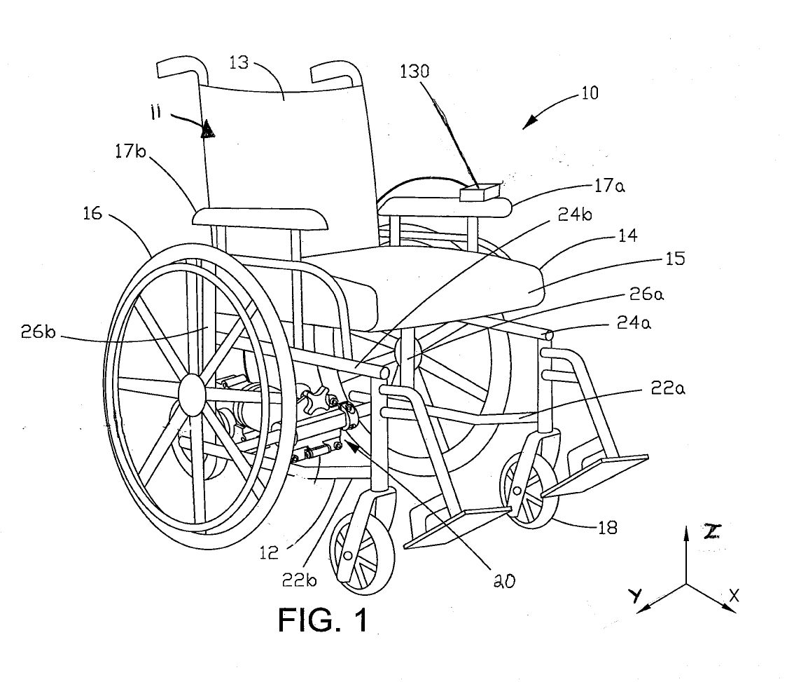

Referring now to the drawings, FIG. 1 shows a wheelchair assembly 10 including a wheelchair 11, and a removable motor assembly 20 removably attached to the wheelchair 11. The motor assembly 20 is configured to be attached to the wheelchair 11 to thereby assist in the movement of the wheelchair 11. The motor assembly 11 is also configured to be easily removed from the wheelchair 11 when the wheelchair assembly 10 is to be transported from one location to another.

The wheelchair 11 may be a conventional manual wheelchair. That is, wheelchair 11 may be a wheelchair that is optionally driven by a user manually applying torque to the wheelchair drive wheels. The wheelchair 11 and motor assembly 20 are described herein as including components that extend horizontally along a longitudinal direction “X” and lateral direction “Y”, and vertically along a transverse direction “Z”. Unless otherwise specified herein, the terms “lateral,” “longitudinal,” and “transverse” are used to describe the orthogonal directional components of various components.

As shown in FIG. 1, the wheelchair 11 is configured to move forward with respect to the front of the occupant in the longitudinal direction X. As shown, the wheelchair 11 includes a frame 12, a seat portion 14 attached to the frame 12, a pair of wheelchair drive wheels 16 attached to the frame 12, and a pair of front wheels 18 attached to the frame 12 forward to the pair of wheelchair drive wheels 16. The seat portion 14 is configured to securely hold a single infirmed occupant and includes a seat bottom 15 and a seat back 13 attached to the seat bottom 15. The seat portion 14 also includes a pair of arm rests 17a and 17b that are attached to the seat bottom 15.

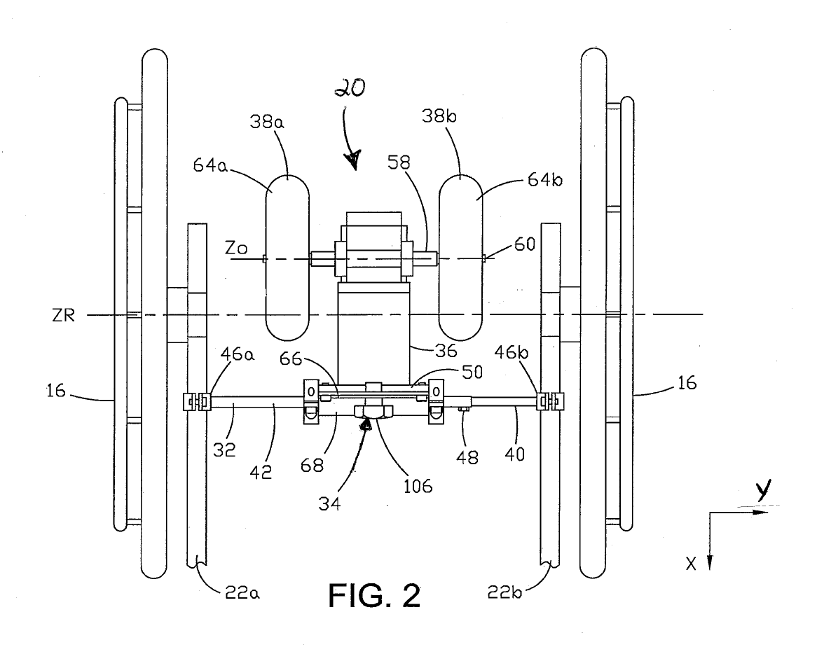

The wheelchair drive wheels 16 each have a diameter that is large enough to allow the occupant of the wheelchair 11 to apply a torque to the wheels 16. The applied torque will move the wheelchair 10 forward, backward, or allow it to turn laterally depending on the direction each wheel 16 is turned. As shown in FIG. 1, the drive wheels 16 are rotatably coupled to the frame 12, proximate to the rear of the frame 12. As shown in FIG. 2, the drive wheels 16 rotate about an axis Z_{R} that is parallel to the lateral direction Y and transverse to the longitudinal direction X.

The front wheels 18 are also rotatably coupled to the frame, but proximate to the front of the frame 12. The front wheels 18 may be caster wheels that are configured to swivel about a vertical axis. The swiveling front wheels 18 therefore allow the wheelchair 11 to turn laterally as torque is applied to the drive wheels 16.

As shown in FIG. 1, the frame 12 includes a pair of opposed parallel lower bars 22a and 22b that are connected to a pair of opposed parallel upper bars 24a and 24b by two sets of vertical bars 26a and 26b. As shown, the lower bars 22a and 22b, the upper bars 24a and 24b, and the vertical bars 26a and 26b generally define a box that supports the seat portion 14.

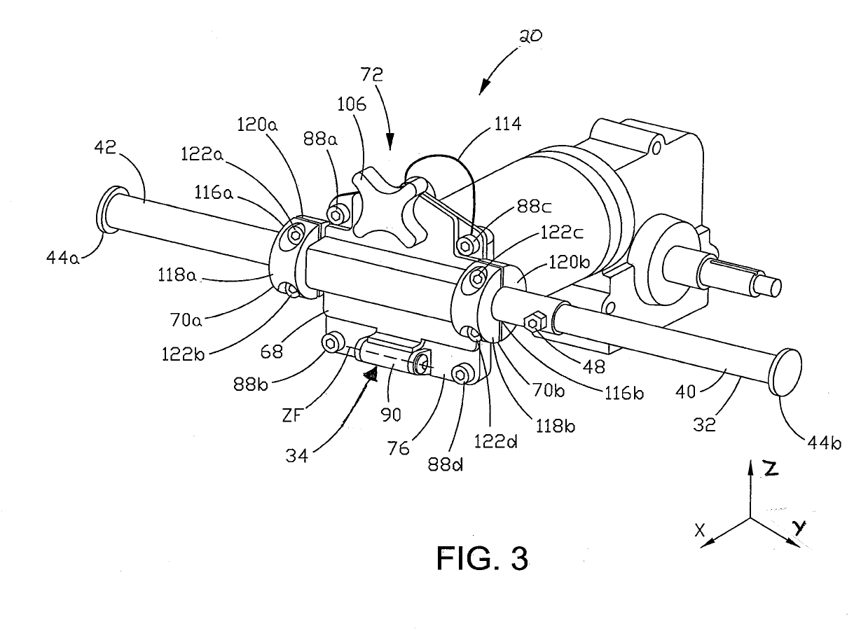

As shown in FIGS. 1-3, the motor assembly 20 is generally attached to the lower bars 22a and 22b of the frame 12. As shown in FIGS. 2 and 3, the motor assembly 20 includes a horizontal crossbar 32, a motor mount bracket 34, and a motor 36 that is attached to the crossbar 32 by the motor mount bracket 34. As shown, the motor assembly 20 is attached to the frame 12 by the ends of the horizontal crossbar 32 so as to connect the lower bar 22a of the frame 12 to the lower bar 22b. That is, the horizontal crossbar 32 extends in the lateral direction Y from the first lower bar 22a to the second lower bar 22b such that the length of the horizontal crossbar 32 is substantially parallel to the axis of rotation Z_{R} of the wheelchair drive wheels 16.

As shown in FIG. 3, the horizontal crossbar 32 includes a first portion 40 and a second portion 42 that is slideably attached to the first portion 40. In particular the second portion 42 may be a tube, and the first portion 40 may at least partially slide within the second portion 42. Therefore, it can be said that the first portion 40 has a telescoping connection with the second portion 42. The first portion 40 and the second portion 42 each include flanges 44a and 44b, respectively, at their outer ends. The flanges 44a and 44b are configured to fit on, or otherwise couple to a pair of brackets 46a and 46b that are attached to the pair of lower bars 22a and 22b of the wheelchair frame 12. Once the flanges 44a and 44b are coupled to the brackets 46a and 46b the crossbar 32 will be secured to the wheelchair 11.

The horizontal crossbar 32 further includes a spring disposed within the second portion 42 that is configured to apply a lateral force against the first portion 40. The spring allows the horizontal crossbar 32 to be a spring loaded bar with telescoping capabilities such that the overall length of the horizontal crossbar 32 is configured to extend and compress along the lateral direction Y.

As shown in FIG. 3, the horizontal crossbar 32 further includes a fitting 48 that is configured to fix the first portion 40 with respect to the second portion 42. In the illustrated embodiment, the fitting 48 is a nut and bolt type configuration. As shown, the fitting 48 is secured to the second portion 42 of the horizontal crossbar 32. By tightening the fitting 48, the fitting 48 contacts the first portion 40 to thereby fix the first portion 40 relative to the second portion 42 and prevent any undesired telescoping of the first and second portions 40 and 42. Loosening the fitting 48, on the other hand, causes the fitting 48 to move away from the first portion 40 to thereby allow the first portion 40 to move relative to the second portion 42.

As shown in FIG. 3, the motor assembly 20 includes a motor 36 that is removably attached to the horizontal crossbar 32 by the motor mount bracket 34. The motor 36 may be any motor that is capable of propelling the wheelchair 11. For example, the motor 36 may be capable of propelling the wheelchair 11 at a maximum drive speed of 3.4 miles/hour. Additionally, the motor 36 may have a maximum range of 10 miles. The motor 36 may be powered by an attached battery. Though not required, the battery may have a size of 1×12V 17/20 Ah and may weigh approximately 15 pounds. The battery may also have an off board charger that delivers 1.5 A. The battery is configured to selectively supply power to the motor 36 to thereby produce a rotational output. The rotational output of the motor 36 drives a pair of motor assembly drive wheels 38a and 38b that rotate about an axis Z_{O}. As shown, the axis Z_{O} is parallel to the wheelchair drive wheel axis Z_{R}.

The rotational output of the motor 36 actuates the pair of motor assembly drive wheels 38a and 38b. The pair of motor assembly drive wheels 38a and 38b are each connected to the rotational output 58 by an axel 60. The axel 60 is connected to the pair of motor assembly drive wheel 38a and 38b. The axel 60 extends lengthwise along axis Z_{O}. The outer rims 64a and 64b of each of the pair of drive wheels 38a and 38b may be made of thick, puncture proof rubber. The motor assembly drive wheels 38a and 38b are each approximately 8 inches in diameter. The pair of motor assembly drive wheels 38a 38b are configured to rotate about axis Z_{O}. The rotation of the motor assembly drive wheels 38a and 38b propel the wheelchair 11 forward along the X axis.

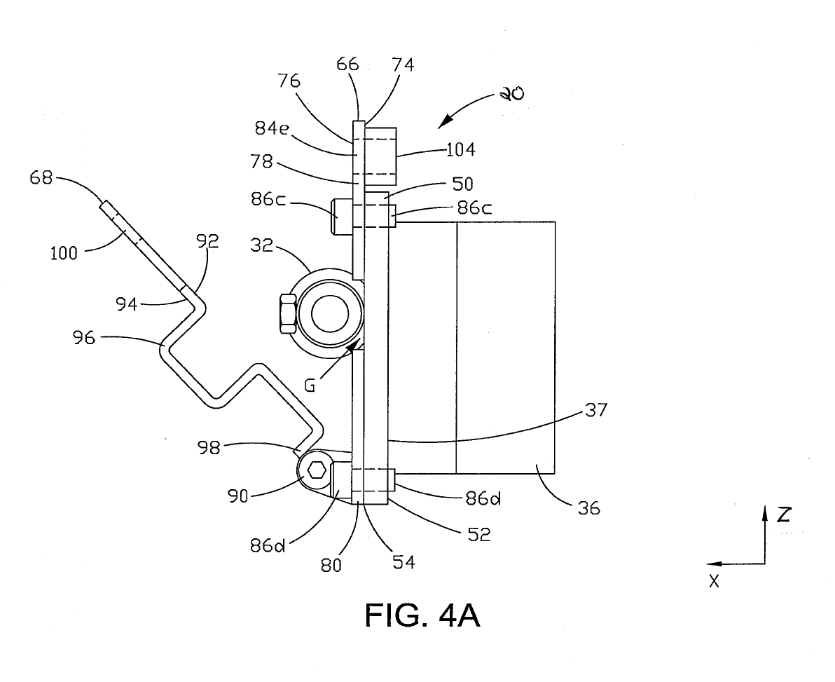

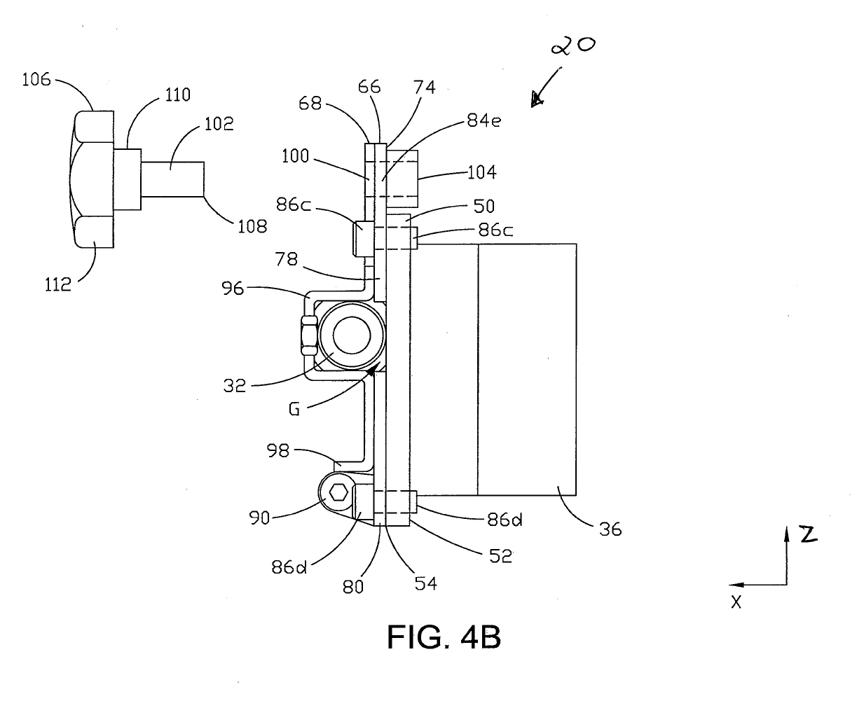

As shown in FIG. 4A, the motor 36 may include a mounting plate 50 that is fixedly attached to a front portion 37 of the motor 36. The front portion 37 of the motor 36 is defined by the front of the motor 36 in relation to the forward motion of the wheelchair assembly 10. As best shown in FIG. 3, the mounting plate 50 is generally rectangular in shape and extends lengthwise and widthwise along the Y and Z directions, respectively. As shown, the mounting plate 50 has a mounting plate rear side 52 that attaches the mounting plate 50 to the motor 36, and a mounting plate front side 54. The mounting plate 50 further defines four mounting plate bores 56a,b,c,d that extend longitudinally through the plate 50 from the front side 54 through to the back side 52. In the illustrated embodiment the bores 56a,b,c,d are located proximate to each corner of the rectangular mounting plate 50. It should be understood, however, that the mounting plate 50 may have any configuration as desired. For example, the mounting plate 50 may be alternatively shaped and may include bores that extend through the plate at different locations.

The motor 36 and in particular the mounting plate 50 is attached to the motor mount bracket 34. The motor mount bracket 34 is configured to releasably attach the motor 36 to the horizontal crossbar 32. As shown in FIGS. 3-5B, the motor mount bracket 34 includes a fixed back plate 66 and a rotatable front plate 68 that is rotatably coupled to the back plate 66. The back plate 66 and the front plate 68 are configured to have a clamped or closed position in which the motor 36 is secured to the horizontal crossbar 32, and an unclamped or open position in which the motor 36 is released and removed from the crossbar 32. The front and back plates 66, and 68 of the bracket 34 are made primarily of a metal, such as steel or aluminum. It should be understood, however, that the front and back plates 66, and 68 may be made of any suitable material.

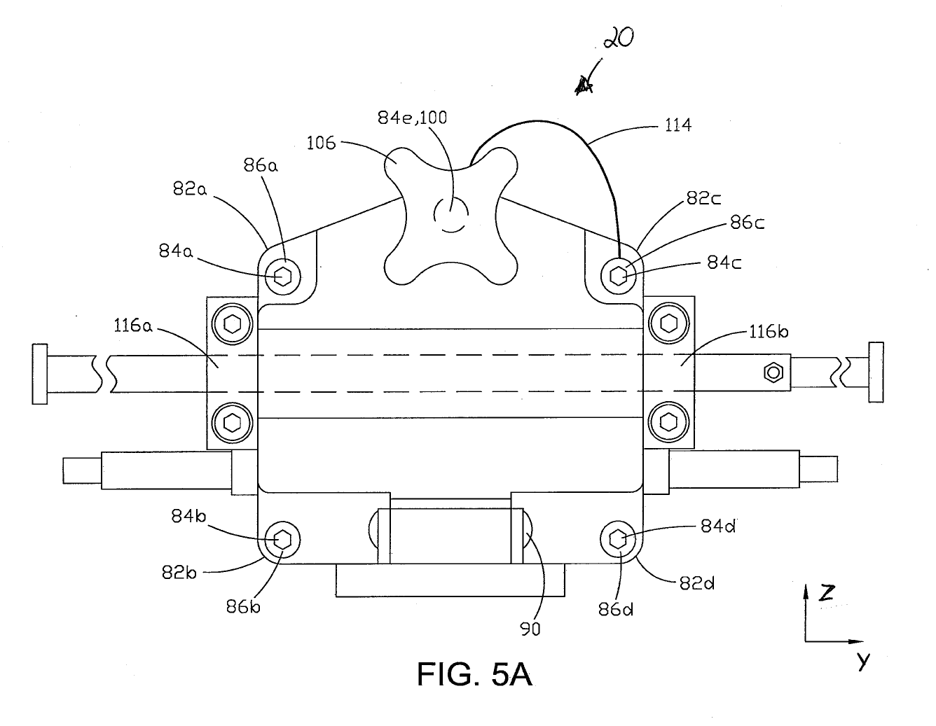

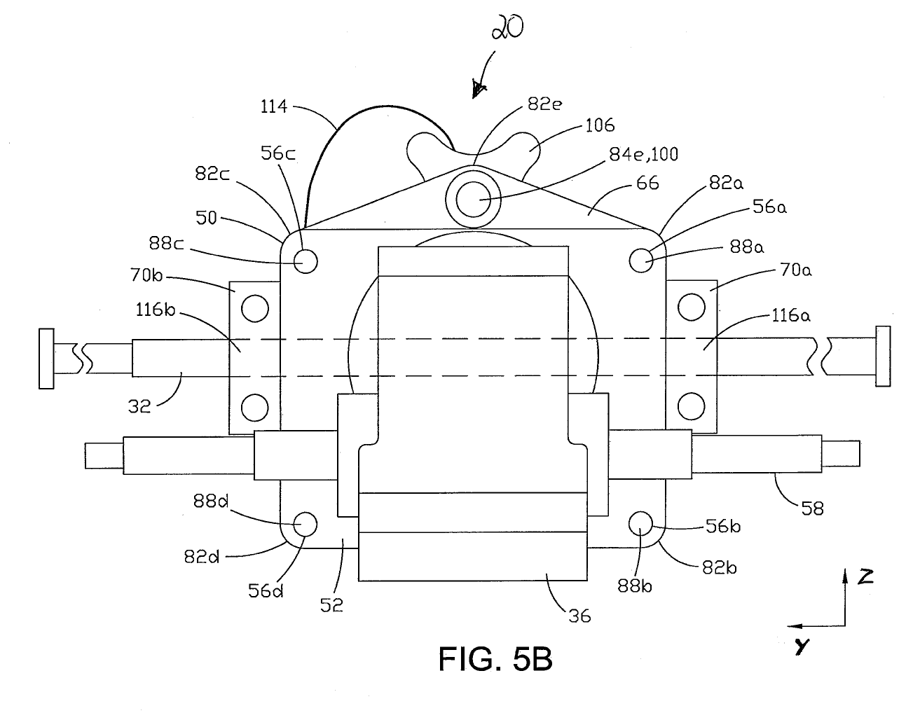

As shown in FIGS. 4A, 4B, and 5B, the back plate 66 has a substantially pentagonal shape and extends lengthwise and widthwise along the Y and Z directions. The back plate 66 includes an upper portion 78 and a lower portion 80, that together define a back plate rear side 74 and a back plate front side 76. The back plate 66 generally lies in the same plane as the mounting plate 50 such that the mounting plate front side 54 is adjacent to the back plate 66 rear side 74. As shown in FIGS. 4A-4B, the upper portion 78 of the back plate 66 extends vertically above the horizontal crossbar 32 and generally has a pentagonal shape. Similarly, the lower portion 80 of the back plate 66 extends below the horizontal crossbar 32 and generally has a rectangular shape. As shown in FIG. 4A, the upper portion 78 and the lower portion 80 of the back plate 66 are spaced apart so as to define a gap G between the upper and lower portions 78, 80. The gap G extends laterally and is configured to receive the horizontal crossbar 32. It should be understood, however, that the upper portion 78 and the lower portion 80 are integral and define a recess that is configured to receive the horizontal crossbar 32.

The back plate 66 defines generally five vertices 82a,b,c,d,e and includes five back plate bores 84a,b,c,d,e that are located proximate to a respective one of the five vertices 82a,b,c,d,e. The back plate bores 84a,b,c,d each extend longitudinally through the back plate 66 from the back plate front side 76 through to the back plate rear side 74, and are configured to align with the mounting plate bores 56a,b,c,d of the mounting plate 50 such that all of the bores 56a,b,c,d, and 84a,b,c,d share center axes and have similar diameters, respectively. Once aligned, fixation members such as bolts 86a,b,c,d may be inserted through the bores 56a,b,c,d, and 84a,b,c,d, respectively. The bolts 86a,b,c,d may then be secured by nuts 88a,b,c,d, respectively, to thereby affix the mounting plate 50 and thus the motor 36 to the back plate 66 of motor mount bracket 34.

As shown in FIGS. 4A and 4B, the front plate 68 is attached to the back plate 66 by a hinge 90 such that the front plate 68 is rotatably connected to the back plate 66. In the illustrated embodiment, the hinge 90 is attached to the lower portion 80 of the back plate 66. In particular, the hinge 90 is located along a bottom edge of the back plate lower portion 80. As shown in FIGS. 3 and 5A, the hinge 90 extends laterally across the lower portion 80 along a portion of the bottom edge. The hinge 90 is configured to allow the front plate 68 to rotate about an axis Z_{F} relative to the back plate 66. As shown, the axis Z_{F} is generally parallel to the direction in which the crossbar 32 extends.

As best shown in FIG. 5A, the front plate 68 of the motor mount bracket 34 has a generally pentagonal shape and extends lengthwise and widthwise along the Y and Z directions. Though the front plate 68 has a generally pentagonal shape, the front plate 68 includes four cut away portions that allow the front plate 68 to lie flush against the back plate 66 when the mounting bracket 34 is in a closed position. In particular, the cut away portions provide clearance for the bolts 86a,b,c,d that extend through the back plate 66 and the mounting plate 50. As shown in FIGS. 4A and 4B, the front plate 68 includes a front plate rear side 92 and a front plate front side 94. When the mounting bracket 34 is in a closed position, the front plate 68 generally lies in the same plane as the back plate 66 such that the back plate front side 76 is adjacent to the front plate rear side 92.

As shown in FIGS. 4A, and 4B, the front plate 68 includes a crossbar receiving portion 96 that defines a C-shaped channel. The channel of the crossbar receiving portion 96 is configured to at least partially receive the horizontal crossbar 32. When the mounting bracket 34 is in a closed position, the channel of the crossbar receiving portion 96 and the gap G defined by the back plate 66 together define a laterally extending through hole that securely holds the mounting bracket 34 to the horizontal crossbar 32.

The front plate 68 further includes a flange 98 located along the bottom edge of the front plate 68 and a bore 100 located near the top of the front plate 68. As shown in FIGS. 4A and 4B, the hinge 90 is attached to the front plate 68 along the flange 98. As shown in FIG. 4B, the front plate bore 100 is configured to align with the back plate bore 84e such that the bores 84e and 100 share center axes and have similar diameters.

As shown in FIGS. 4A-5B, the motor mount bracket 34 further includes a fixation apparatus 72 that is configured to extend through the bores 84e and 100 of the front and back plates 66, and 68 to thereby lock the front plate 66 to the back plate 68. The fixation element 72 includes a fixation member having a knob 106 and a shaft 102 that extends from the knob 106. The shaft 102 includes a rear portion 108 and an opposed front portion 110. The fixation element 72 further includes a nut 104 that is configured to be removably attached to the front portion 110 of the shaft 102. In the illustrated embodiment, the shaft 102 includes external threads and the nut 104 includes internal threads that are configured to engage the external threads of the shaft 102 to thereby lock the fixation element 72 to the front and back plates 66, 68. When the nut 104 is removed from the shaft 102, the fixation member may be removed from the bores 84e, 100. To prevent the fixation member from being lost, the fixation member is attached to the back plate 66 by a knob wire 114.

As shown in FIGS. 5A and 5B, the motor assembly 20 further includes a centering feature such as a pair of collar clamps 70a and 70b that are fixedly attached to the horizontal crossbar 32 such that the motor mount 34 may be coupled to the crossbar 32 between the clamps 70a and 70b so as to automatically center the motor mount 34 to the crossbar 32. The collar clamps 70a and 70b are positioned on the second portion 42 of the crossbar 32 to ensure that the motor 36 is centered with respect to the wheelchair 11 when the motor 36 is attached to the crossbar 32 via the motor mount 34. Therefore, when the motor assembly 20 is removed from and then subsequently reattached to the wheelchair 11, the motor 36 will always be centered with respect to the wheelchair 11. This will save time and effort on the part of the individual assembling the wheelchair assembly 10. While the collar clamps 70a and 70b are described as being separate components from the crossbar 32, it should be understood that the collar clamps 70a and 70b and the crossbar 32 may be integral and may be manufactured as a single unitary unit.

In the illustrated embodiment, the collar clamps 70a and 70b each have a generally cylindrical shape and define center bores 116a and 116b. The center bores 116a and 116b have a diameter that is sized to receive the horizontal crossbar 32. The center bores 116a and 116b and the horizontal crossbar 32 generally have the same center axis.

The collar clamps 70a and 70b each include a collar clamp front portion 118a and 118b and a collar clamp rear portion 120a and 120b, respectively. Each of the collar clamp front portions 118a and 118b and collar clamp rear portions 120a and 120b are substantially identical in shape and comprise approximately half of each of the collar clamps 70a and 70b. In this way, each of the collar clamp front portions 118a and 118b and collar clamp rear portions 120a and 120b form a C-shape. Each of the collar clamp front portions 118a and 118b and collar clamp rear portions 120a and 120b further comprise collar clamp bores (not shown). The collar clamps 70a and 70b further include collar clamp bolts and nuts 122a,b,c,d that are configured to extend through the bores 124a,b,c,d and couple the clamp front portions 118a and 118b to the clamp rear portions 120a and 120b.

The wheelchair assembly 10 further includes a control system 130 for controlling the operation of the motor 36. The control system 130 includes a control box 132 that may be mounted on one of the pair of arm rests 17a, and 17b of the seat portion 14 of the wheelchair 11. The control system 130 further includes a control wire 134 that electrically and operatively connects the motor 36 and the control box 132. It should be understood that any control box may be used so long as the control box can operatively control the motor 36.

To attach the motor assembly 20 to the wheelchair 11, the horizontal crossbar 32 is first affixed to the lower bars 22a and 22b of the wheelchair frame 12 by coupling the crossbar flanges 44a and 44b to the pair of brackets 46a and 46b on the lower bars 22a and 22b. The telescoping aspect of the horizontal crossbar 32 makes it possible to shorten the length of the horizontal crossbar 32 prior to coupling the flanges 44a and 44b to the pair of brackets 46a and 46b. Once the compressed crossbar 32 is placed between the lower bars 22a and 22b of the wheelchair frame 12, the crossbar 32 may then be extended and secured into position.

Once the horizontal crossbar 32 is secured on the pair of lower bars 22a and 22b, the motor 36 can be attached to the horizontal crossbar 32 by clamping the motor mount bracket 34 to the crossbar 32 between the collar clamps 70a and 70b. Prior to mounting, the motor mount bracket 34 is in an open or unclamped position as shown in FIG. 4A. That is, the front plate 68 is rotated away from the back plate 66 about axis Z_{F}. The motor mount bracket 34, and thus the motor 36, is then positioned relative to the horizontal crossbar 32 so that the pair of motor assembly drive wheels 38a and 38b are located rearward to the crossbar 32 in relation to the forward movement of the wheelchair 11. As shown in FIG. 4A, the horizontal crossbar 32 is positioned in the gap G between the back plate upper portion 78 and the back plate lower portion 80.

Once the horizontal crossbar 32 is positioned in the gap G, the front plate 68 can be rotated about axis Z_{F} to a closed or clamped position as shown in FIG. 4B. In the closed position, the crossbar 32 is received within the channel of the crossbar receiving portion 96 defined by the front plate 68. In the closed position, bores 84e and 100 of the front and back plates 66, and 68 align so that the shaft 102 of the fixation element 72 may fit through the bores 84e, and 100. The fixation element 72 is then secured by threading the nut 104 onto the shaft 102. When the fixation element 72 is secured, the front plate 68 and the back plate 66 are pressed together between the collar clamps 70a and 70b, to thereby securely lock the motor 36 to the horizontal crossbar 32. With the horizontal crossbar 32 secured in the mounting bracket 34, the motor assembly 20 is secured to the wheelchair 11. The wheelchair 11 may then be at least partially propelled by the motor 36 using the control system 130.

It will be appreciated by those skilled in the art that changes could be made to the embodiments described above without departing from the broad inventive concept thereof. Furthermore, it should be appreciated that the structure, features, and methods as described above with respect to any of the embodiments described herein can be incorporated into any of the other embodiments described herein unless otherwise indicated. It is understood, therefore, that this invention is not limited to the particular embodiments disclosed, but it is intended to cover modifications within the spirit and scope of the present disclosure.

What is claimed:

1. A removable motor assembly configured to be removably attached to a manual wheelchair, the removable motor assembly comprising:
a crossbar including a first collar and a second collar spaced apart from the first collar along the crossbar, the crossbar configured to couple to a frame of a manual wheelchair;
a motor operatively coupled to a pair of motor assembly drive wheels;
a back plate coupled to the motor; and
a front plate rotatably coupled to the back plate between:
(i) a clamped position in which the back and front plates are clamped on to a portion of the cross bar between the first and second collars to thereby affix the motor to the crossbar, and
(ii) an unclamped position in which the motor is removed from the crossbar.

2. The removable motor assembly of claim 1, wherein the back plate defines a first bore, and the front plate defines a second bore that is aligned with the first bore of the back plate when the front plate is in the clamped position, the assembly further comprising a fixation element that is configured to extend through the first and second bores so as to lock the back and front plates to the cross bar.

3. The removable motor assembly of claim 2 wherein the fixation element includes a fixation member and a nut, the fixation member having a knob and a shaft that is configured to extend through the first and second bores and then subsequently coupled to the nut so as to lock the motor to the crossbar.

4. The removable motor assembly of claim 1, wherein the back plate includes un upper portion and a lower portion that is spaced apart from the upper portion to thereby define a gap between the upper and lower portions, the gab configured to receive the crossbar.

5. The removable motor assembly of claim 1, wherein the front plate defines a C-channel that is configured to receive the cross bar.

6. The removable motor assembly of claim 1, wherein the crossbar includes a first portion and a second portion that is slidably attached to the first portion.

7. The removable motor assembly of claim 6, wherein the crossbar includes a spring disposed within the second portion, the spring configured to apply a lateral force against the first portion.

8. The removable motor assembly of claim 7, wherein the crossbar further includes a fitting that is configured to fix the position of the first portion relative to the second portion.

9. The removable motor assembly of claim 1, wherein the front plate is rotatably coupled to the back plate by a hinge.

10. The removable motor assembly of claim 1, wherein the first and second collars each include a clamp front portion and a clamp rear portion that is coupled to the clamp front portion.

11. The removable motor assembly of claim 1, wherein the crossbar includes a first portion and a second portion that have a telescoping relationship, the second portion including the first and second collars.

12. A removable motor assembly configured to be removably attached to a manual wheelchair, the removable motor assembly comprising:
a crossbar including a first portion and a second portion that is slidably coupled to the first portion such that the first portion is compressible relative to the second portion, the second portion defining a centering feature;
a motor operatively coupled to a pair of motor assembly drive wheels; and
a motor mount bracket coupled to the motor, the motor mount bracket is configured to have:
(i) a clamped position in which the motor mount bracket is coupled to the crossbar to thereby affix the motor to the crossbar, and
(ii) an unclamped position in which the motor mount bracket and motor are removed from the crossbar,
wherein the motor mount bracket is automatically centered on the second portion of the crossbar by the centering feature when the motor mount bracket is clamped onto the crossbar.

13. The removable motor assembly of claim 12, wherein the centering feature includes a first collar coupled to the second portion of the crossbar and a second collar coupled to the second portion of the crossbar such that the second collar is spaced apart from the first collar along the second portion of the crossbar.

14. The removable motor assembly of claim 13, wherein the first and second collars each include a clamp front portion and a clamp rear portion that is coupled to the clamp front portion.

15. The removable motor assembly of claim 13, wherein the first and second collars are collar clamps.

16. The removable motor assembly of claim 12, wherein the motor mount bracket includes a back plate and a front plate that is rotatably coupled to the back plate by a hinge.

17. The removable motor assembly of claim 16, wherein the back plate includes an upper portion and a lower portion that is spaced apart from the upper portion to thereby define a gap between the upper and lower portions, the gab configured to receive the crossbar.

18. The removable motor assembly of claim 17, wherein the front plate defines a C-channel that is configured to receive the cross bar.

19. A method of mounting a motor assembly to a manual wheelchair, the method comprising:
attaching a crossbar to a frame of a manual wheelchair by sliding a first portion of the crossbar relative to a second portion of the crossbar so as to expand a length of the crossbar;
providing a motor and a motor mount bracket attached to the motor, wherein (i) the motor is operatively coupled to a pair of motor assembly drive wheels, and (ii) the motor mount bracket includes a back plate that is attached to the motor, and a front plate that is rotatably attached to the back plate by a hinge;
rotating the front plate about the hinge to thereby provide access to a channel that is defined by the front plate;
positioning the motor mount such that the crossbar is between the front and back plates; and
rotating the front plate about the hinge such that the crossbar is received within the channel defined by the front plate.

20. The method of claim 19, wherein the front and back plates each define a bore that extends therethrough, the method further comprising,
inserting a fixation apparatus through the bores of the front and back plates to thereby secure the back and front plates to the cross bar.
